(19) United States
(12) Patent Application Publication
(10) Pub. No.: US 2008/0227055 A1
(43) Pub. Date: Sep. 18, 2008

(54) Dental hygiene device applicable for a variety of gum conditions

(76) Inventor: Paul Lorin Seidman, Brooklyn, NY (US)

Correspondence Address: Ms. Susan Meisner, 8750 Bay Parkway, Brooklyn, NY, 11214, US

(21) Appl. No.: 11/825,334

(22) Filed: Jul. 5, 2007

Related U.S. Application Data
(60) Provisional application No. 60/818,382, filed on Jul. 5, 2006.

(51) Int. Cl. A61C 3/00; A41D 19/00

(52) U.S. Cl. 433/141; 2/160

(57) ABSTRACT

A portable, foldable, dental hygiene device providing a plurality of options for election by the user applicable to dental hygiene procedures suitable for persons with different dental hygiene needs. The invention comprising a glove-like structure with finger-like extensions, each finger extension furnished with respectively different surface texture suitable for various gum and tooth conditions.

### RELATED APPLICATION

This application is based upon and claims priority to Provisional Application, U.S. Ser. No. 60/818,382, filed Jul. 5, 2006.

### BACKGROUND OF INVENTION

Frequent cleaning of teeth and removal of fragments of food from between the teeth is a universal dental hygiene need for adults, young children, infants and on occasion, for pets. Conventional dental hygiene using a special brush, as required for instance for a child compared to a brush suitable for an adult, with toothpaste or tooth powder and available sanitary running water is not convenient to provide at all times. Dental hygienic needs of children and infants vary significantly from time to time. An infant needs frequent dental care which must be conducted gently. Young children suffer from gum discomfort while losing infant teeth and the eruption of permanent teeth. However, the young child's gums adjacent the erupting tooth may be tender. The young child's remaining teeth require hygienic care often with more vigorous rubbing and polishing. Adults require vigorous application of brush or other dental polishing devices applied to their teeth, except when a specific portion of an adults' gums or tooth area is diseased or has been recently subjected to one or more professional dental procedures.

There is a widespread need for a portable, and as appropriate a disposable, dental hygiene device with which effective normal and vigorous dental hygiene tooth scouring and polishing may be conducted during times when normal dental hygiene facilities such as brushes, toothpaste and sanitary running water is not available. However, such a portable dental device, to provide the variety of dental purposes when the subject individual is experiencing gum discomfort or tooth disease and a portion of the persons mouth requires special less vigorous dental hygiene practice, a portable, compact dental device which serves multiple mouth conditions is required. The present invention is intended to be a single, compact, portable device to serve the needs of these varied conditions.

There have been a large number of non-conventional, portable and frequently disposable dental hygiene devices disclosed in the literature. These earlier dental devices include disposable finger devices of various kinds. Many of these earlier references disclosed devices substantially equivalent to a fixed bristle finger tooth brush, while other of these earlier references disclose a tooth polishing tool.

A selection of these earlier references in the patent literature are:

| | | |
|---|---|---|
| U.S. Pat. No. 5,524,764 | Kaufman | Tooth Polishing |
| U.S. Pat. No. 7,020,898 | Pucci | A mitt for multiple cleaning purposes, |
| | | including dental hygiene. |
| U.S. Pat. No. 5,348,153 | Cole | Finger tooth brush |
| U.S. Pat. No. 6,874,194 | Harris | Finger tooth brush. |
| U.S. Pat. No. 5,107,562 | Dunn | Finger tooth brush |
| U.S. Pat. No. 6,647,549 | McDevitt | Finger glove for tooth |
| U.S. Pat. No. 6,105,587 | Dunn | Disposable Finger tooth brush |
| U.S. Pat. No. 5,068,941 | Dunn | Finger mounted tooth brush |
| U.S. Pat. No. 4,134,172 | Arce | Disposable tooth brush |

These references, which comprise only a selection from the literature of portable disposable dental hygiene devices, all fail to address the need in one, compact, portable dental device for varied response options for a subject user with sore or diseased gums or teeth. Such a subject user requires varied but compact portable means within a dental hygiene device to treat both the normal healthy portions of his or her mouth as well as sections of his/her mouth experiencing painful gums or tooth discomfort.

### BRIEF SUMMARY OF THE INVENTION

The present invention provides in a portable, and as desired, disposable, compact dental hygiene device having optional means for response to persons having widely different dental hygiene requirements.

The present invention comprise a light-weight, foldable glove-like structure with hollow extensions connected thereto for the user's fingers and thumbs. The finger extension surfaces are, respectively, each provided with different textured surfaces having different hardness and abrasiveness, adapted, respectively, to providing a series of different dental hygiene options for the user.

The glove-like structure and finger extensions may be formed of thin membrane material such as polymer sheet. The glove-like structure with its varied surface textured finger extensions may be readily folded into a compact, readily portable dental accessory.

Accordingly, the purpose of my invention is to provide a compact portable, and as desired, disposable dental hygiene device affording varied options for conduct of dental hygiene processes on behalf of different individuals such as adults, young children or infants. In addition, my invention provides options for varied dental hygiene processes for different portions of one person's gums or teeth, when such person is experiencing gum or tooth discomfort.

### DESCRIPTION OF DRAWINGS

FIG. 1. Perspective view of a preferred embodiment of my invention.

FIG. 2. Perspective view of a modified second preferred embodiment of my invention.

FIG. 3. A fragmentary view of a portion of my invention showing the hollow extension for a user's thumb.

FIG. 4. A fragmentary view of a portion of my invention showing the hollow extension for the index finger.

FIG. 5. A fragmentary view of a portion of my invention showing the middle finger extension.

FIG. 6. A fragmentary view of my invention showing the fourth finger extension.

FIG. 7. A fragmentary view of my invention showing the little finger extension of the preferred embodiment shown in FIG. 1.

FIG. 8. A fragmentary view of the embodiment of my invention illustrated in FIG. 2 wherein attachments to the little finger extension are shown in perspective.

### DETAILED DESCRIPTION OF THE DRAWINGS

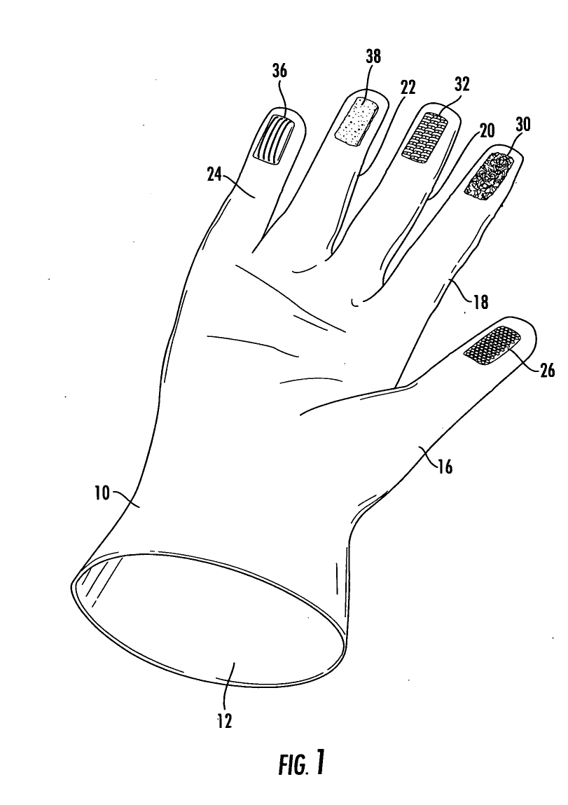

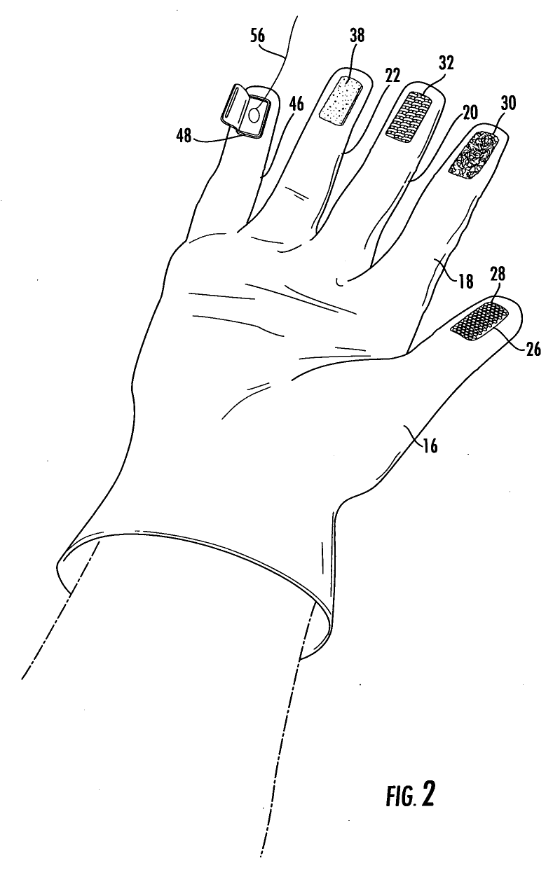

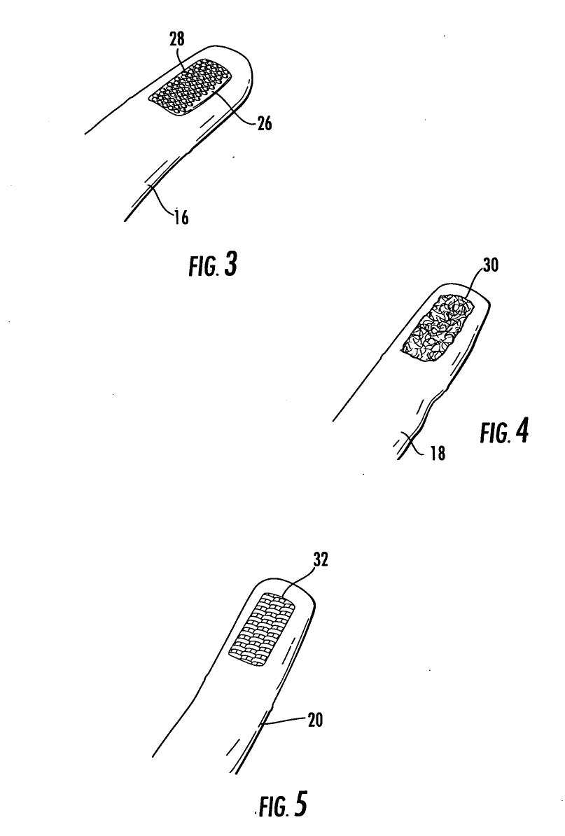

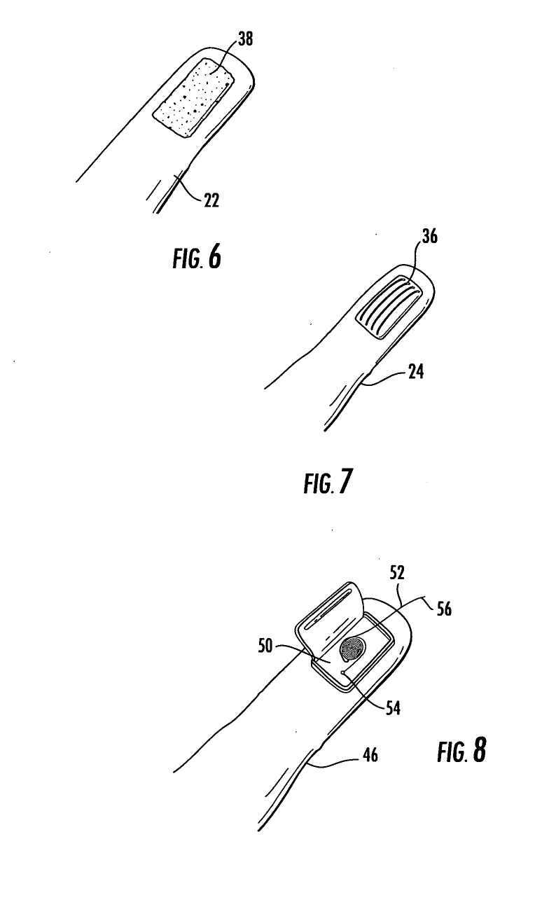

Referring to the drawings, FIG. 1 is a perspective view of a preferred embodiment of my invention. A hollow enclosure 10, shaped similarly to a glove, has an open end, 12 at one end thereof and five hollow extensions 16, 18, 20, 22, and 24, attached to and connected internally to the hollow enclosure. The hollow extensions 16, 18, 20, 22 and 24 are sized and positioned when secured to the enclosure 10 to accommodate a persons thumb and fingers when his/her hand is inserted into the hollow enclosure, 10.

My invention contemplates providing both right handed and left handed versions of the glove-like hollow enclosure 10.

At the end of the thumb extension 16, a rubber pad 26 is securely attached. The pad 26 is provided with an irregular surface 28. The irregula surface 28 may be formed with small hollows formed below the surface 28. The surface irregularities may be also formed on the pad surface 28. The rubber pad, 26, with irregular surface, 28, provides firm structured surface for normal dental hygiene procedures using substantial pressure on teeth and gums as the user elects.

At the end of the index finger extension 18, a pad, 30, formed of a mildly abrasive felt material is securely attached. The abrasive felt material, may when applied with repeated motion to the user's teeth, furnish means to polish the user's tooth surfaces.

The middle finger extension, 20, is provided with a double cross stitched nylon pad, 32. The cross stitched nylon pad provides a means to apply intermediate hygiene motion stress to the user's teeth and gums.

The fourth finger extension, 22, at the end thereof, has an absorbent cellulose sponge pad, 34, securely attached thereto. The absorbent sponge is adapted to assist cleaning an infant or small child's mouth and teeth.

The small finger extension, 24, is furnished with a small pad, 34. The pad, 34, has short lengths of nylon dental floss, 36. The dental floss sections, 36, are firmly attached at each end thereof to the pad, 34. Using the short lengths of dental floss 36 the user may dislodge food from between his or her teeth.

FIG. 2 is a perspective view of a preferred second embodiment of my invention. To provide a means for more easily inserting the user's hand in my dental hygiene device, a truncated, shortened, glove-like hollow structure, 40, is equipped with an opening, 42, through which the user's hand may be easily inserted. The glove-like hand enclosure, 40, may be sparingly designed to provide minimum grip on the user's hand. One sparing design of the second embodiment of my invention is illustrated in FIG. 2.

The abbreviated glove-like hollow structure, 40, is furnished with five hollow finger extensions 16, 18, 20, 22 and 24. The hollow finger extensions are attached to the hollow structure, 40, to open into the interior of the hollow glove-like structure, 40.

The hollow finger extensions in the second embodiment of my invention shown in FIG. 2 are similar in all ways to the finger extensions shown in FIG. 1, illustrative of the first preferred embodiment of my invention, with the exception of the small finger extension.

The little finger hollow extension, 46, in the embodiment illustrated in FIG. 2 is furnished with a closable pocket, 50. A length of dental floss, 52, is firmly attached at one end, 54, to the interior of the closable pocket, 50. The remaining end, 56, of dental floss, 52, is coiled into a small diameter and stored in the closable pocket, 50, until retrieved to remove food particles from between the users teeth.

The foregoing descriptions of specific embodiments of my invention are intended only for illustration of my invention, but do not exhaust the configurations which others skilled in the art may disclose using my invention. Accordingly, the scope of my invention is defined by the following claims.

I claim:

1. A concise dental hygiene device comprised of a flexible membrane hollow enclosure having an interior surface and an exterior surface, the enclosure being of the size and shape of a persons hand, five hollow extensions extending from the enclosure, said extensions opening into the hollow interior of the enclosure, the five hollow extensions corresponding to the normal size, length and positions of a persons five fingers, the five extensions each having external end portions and rectangular abrasive friction covering pads, each pad having one of several varied frictional densities and varied surfaces, the four pads each securely a fixed, respectively, to the exterior surface end portion of five of the respective finger extensions, whereby dental hygiene procedures may be conducted by a person using a selected optional varied abrasive friction surface and a varied density dental hygiene surface pad.

2. The dental hygiene hollow membrane device of claim 1 having a removably covered receptacle container, the receptacle being firmly attached to the exterior end portion of one of the finger hollow extensions, having a length of dental floss, the dental floss having a first end and a second end, the first end of the dental floss being securely attached to the interior of the receptacle container beneath the removable cover, the dental floss being coiled and stored in the receptacle container under the cover thereof, whereby dental hygiene procedures requiring application of dental floss between the users teeth may be readily conducted with the attached length of dental floss.

3. A glove-like hollow structure having five hollow extensions thereto, the hollow extensions being of the size and position of a persons fingers, attached to and opening into the hollow glove-like structure, five pads attached respectively to the exterior surfaces respectively of the hollow finger extensions, the pads having each respectively surfaces different in firmness and abrasiveness, whereby the user by inserting his or her hand and fingers into the glove-like extensions may select one or more different varied firmness pad surfaces with which to conduct a dental hygiene procedure.
